(19) United States
(12) Patent Application Publication
(10) Pub. No.: US 2026/0086493 A1
(43) Pub. Date: Mar. 26, 2026

(54) IMAGE FORMING APPARATUS

(71) Applicant: CANON KABUSHIKI KAISHA, Tokyo (JP)

(72) Inventor: TOMOMICHI KAWASHIMA, Shizuoka (JP)

(21) Appl. No.: 19/340,247

(22) Filed: Sep. 25, 2025

(30) Foreign Application Priority Data
Sep. 26, 2024 (JP) 2024-167320

(51) Int. Cl. G03G 21/16; G03G 15/00

(52) U.S. Cl. CPC G03G 21/1633; G03G 15/6511; G03G 15/6514; G03G 2215/00392; G03G 2215/00679; G03G 2221/1687; G03G 2221/169

(57) ABSTRACT

An image forming apparatus includes: an apparatus body; an opening and closing member; a connection member having a first engagement portion that is engaged with the apparatus body and a second engagement portion that is engaged with the opening and closing member; a pressing member having a third engagement portion that is engaged with the connection member, a pressing portion that is capable of pressing the pressed portion of the opening and closing member, and an urged portion; an urging member urging the urged portion such that the pressing portion is pressed against the pressed portion. The second engagement portion is movable between a first position and a second position. When the opening and closing member is between a closed position and an open position, the pressing portion moves relative to the pressed portion while pressing the pressed portion, in conjunction with rotation of the opening and closing member.

### BACKGROUND

### Field of the Technology

The present disclosure relates to an image forming apparatus.

### Description of the Related Art

Some image forming apparatuses include an opening and closing member rotatably supported relative to the apparatus body. Examples of such opening and closing members include a door that opens and closes an opening provided in the apparatus body for attaching and detaching cartridges to and from the apparatus body, a tray on which special recording media such as postcards or label sheets are placed when performing manual printing on the recording media, and the like. The user opens and closes the opening and closing member as needed. Japanese Patent Application Laid-open No. 2013-224986 and Japanese Patent Application Laid-open No. 2019-91019 disclose image forming apparatuses having a mechanism that applies a braking force to the opening and closing operation of the opening and closing member.

### SUMMARY

The present disclosure is directed to provide an image forming apparatus that allows a user to apply an appropriate braking force to an opening and closing operation when opening and closing the opening and closing member.

An image forming apparatus according to the present disclosure includes:

an apparatus body;

an opening and closing member being rotatable relative to the apparatus body and having a pressed portion;

a connection member that connects the apparatus body and the opening and closing member, the connection member having a first engagement portion that is engaged with the apparatus body and a second engagement portion that is engaged with the opening and closing member, the connection member being movable relative to the apparatus body and the opening and closing member,

a pressing member having a third engagement portion that is rotatably engaged with the connection member, a pressing portion configured to press the pressed portion, and an urged portion; and

an urging member configured to apply an urging force to the urged portion such that the pressing portion is pressed against the pressed portion,

wherein the second engagement portion is movable relative to the opening and closing member between a first position and a second position in conjunction with rotation of the opening and closing member,

wherein the opening and closing member is rotatable between a closed position where the second engagement portion is in the first position and an open position where the second engagement portion is in the second position, and

wherein, in a case where the opening and closing member is between the closed position and the open position, the pressing portion moves relative to the pressed portion while pressing the pressed portion under the urging force of the urging member, in conjunction with the rotation of the opening and closing member.

Features of the present disclosure will become apparent from the following description of embodiments with reference to the attached drawings. The following description of embodiments is described by way of example.

### BRIEF DESCRIPTION OF THE DRAWINGS

FIG. 1 is a partial cross-sectional view of an image forming apparatus in a state in which a manual feeding tray is closed, according to a first embodiment.

FIG. 2 is a partial cross-sectional view of the image forming apparatus in a state in which the manual feeding tray is opened, according to the first embodiment.

FIG. 3 is a perspective view illustrating a manual sheet feeding portion in a state in which the manual feeding tray is opened, according to the first embodiment.

FIG. 4 is an exploded perspective view illustrating an essential part of the manual sheet feeding portion according to the first embodiment.

FIG. 5A is a view illustrating a state in which the manual feeding tray is in the closed position, according to the first embodiment.

FIG. 5B is a view illustrating a state in which the manual feeding tray is in the open position, according to the first embodiment.

FIG. 6A is a view illustrating a state in which the manual feeding tray is slightly opened from the closed position, according to the first embodiment.

FIG. 6B is a view illustrating a state in which the manual feeding tray is slightly opened from the closed position, according to the first embodiment.

FIG. 7A is a view illustrating a state in which the manual feeding tray is opened further than the state illustrated in FIGS. 6A and 6B, according to the first embodiment.

FIG. 7B is a view illustrating a state in which the manual feeding tray is opened further than the state illustrated in FIGS. 6A and 6B, according to the first embodiment.

FIG. 8A is a view illustrating a state in which the manual feeding tray is opened further than the state illustrated in FIGS. 7A and 7B, according to the first embodiment.

FIG. 8B is a view illustrating a state in which a sheet loading plate is in the sheet feeding position, according to the first embodiment.

FIG. 9 is a perspective view illustrating a manual sheet feeding portion according to a second embodiment.

FIG. 10 is an exploded perspective view illustrating an essential part of the manual sheet feeding portion according to the second embodiment.

FIG. 11A is a view illustrating a state in which the manual feeding tray is slightly opened from the closed position, according to the second embodiment.

FIG. 11B is a view illustrating a state in which the manual feeding tray is slightly opened from the closed position, according to the second embodiment.

FIG. 12A is a view illustrating a state in which the manual feeding tray is opened further than the state illustrated in FIGS. 11A and 11B, according to the second embodiment.

FIG. 12B is a view illustrating a state in which the manual feeding tray is opened further than the state illustrated in FIGS. 11A and 11B, according to the second embodiment.

### DESCRIPTION OF THE EMBODIMENTS

### First Embodiment

Hereinafter, embodiments of the present disclosure will be described with reference to the drawings. However, the components described in the embodiments are merely illustrated examples and are not intended to limit the scope of the present disclosure. The embodiments of the present disclosure will be described using a color image forming apparatus of an electrophotographic and four-drum tandem type. Here, the image forming apparatus is an apparatus that forms toner images on the basis of externally-input image information and transfers and fixes color images onto media such as paper using a known electrophotographic technique. Examples of the image forming apparatus include a copier, a laser beam printer, a facsimile machine, and the like. In a first embodiment, a color laser beam printer will be described as an example.

### Configuration of Image Forming Apparatus

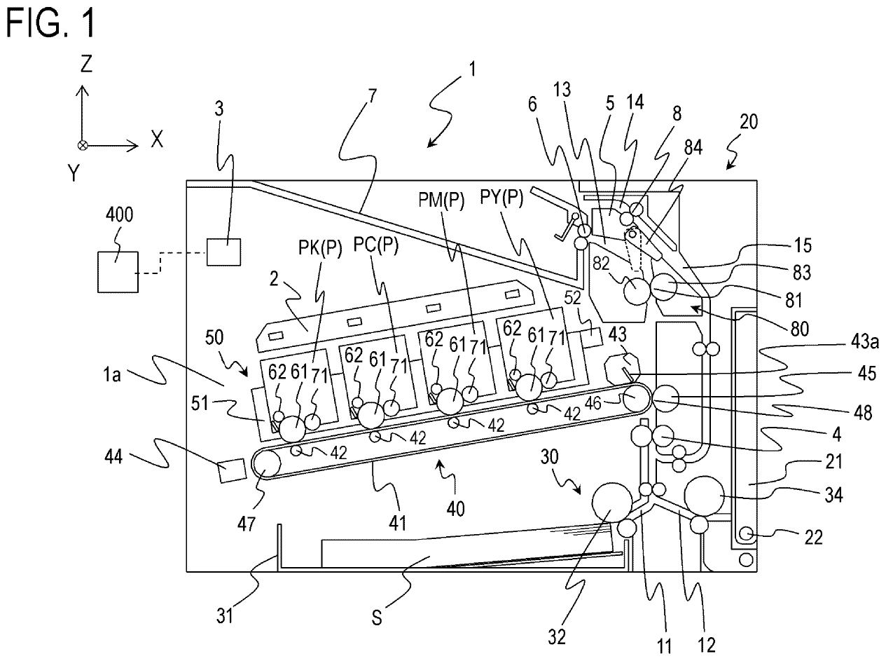

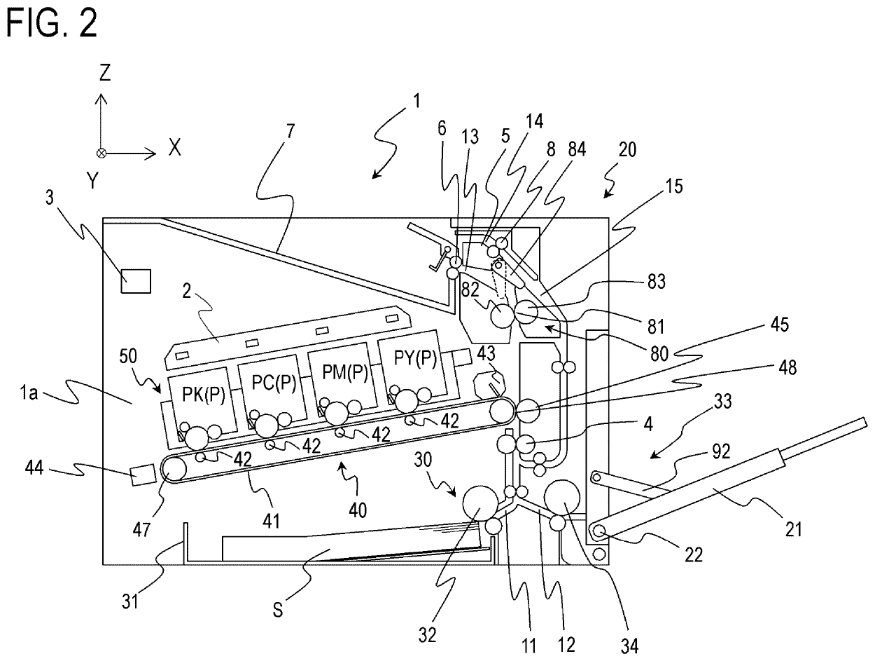

An image forming apparatus 1 according to the first embodiment will be described with reference to FIGS. 1 and 2. FIG. 1 is a partial cross-sectional view illustrating the overall configuration of the image forming apparatus 1 in a state in which a manual feeding tray 21 is closed. FIG. 2 is a partial cross-sectional view illustrating the overall configuration of the image forming apparatus 1 in a state in which the manual feeding tray 21 is opened. The image forming apparatus 1 is a printer that forms images on sheets S used as recording media. As illustrated in FIG. 1, the X, Y, and Z directions are defined. The X direction represents the longitudinal direction of the apparatus, and the right side in the figure corresponds to the front side of the apparatus. The Y direction represents the horizontal direction of the apparatus, and the Z direction represents the vertical direction of the apparatus.

The image forming apparatus 1 mainly has a scanner 2, a control portion 3, a front door 20, a sheet feeding portion 30, a transfer unit 40, a cartridge tray unit 50, and a fixing device 80.

The sheet feeding portion 30 has a cassette 31 on which sheets S used as recording media are loaded, and a feeding roller 32. The cassette 31 may be pulled out toward the front door 20 (the X direction) to replenish the sheets S.

The cartridge tray unit 50 has a tray 51 and cartridges PY, PM, PC, and PK. The tray 51 has a tray handle 52. The cartridges PY, PM, PC, and PK are attached so that they are removable from the tray 51.

Each of the cartridges PY, PM, PC, and PK is attachable to and detachable from the tray 51 independently of each other. The cartridges PY, PM, PC, and PK accommodate yellow (Y), magenta (M), cyan (C), and black (K) toner (developers), respectively. The cartridges PY, PM, PC, and PK have the same configuration, except that the toner they accommodate differs in color. Therefore, the configuration and the operation of one of the cartridges PY, PM, PC, and PK will be described, and the description of the other cartridges may be omitted. Furthermore, when the cartridges PY, PM, PC, and PK do not need to be distinguished from each other, they may be simply referred to as cartridges P.

The cartridge tray unit 50 has four photosensitive drums 61 that serve as image bearing members, four charging rollers 62 that serve as charging members, and four developing rollers 71 that serve as developer bearing members. The rotational axis directions of the photosensitive drums 61, the developing rollers 71, and the charging rollers 62 are parallel to each other.

The photosensitive drums 61, the charging rollers 62, and the developing rollers 71 may be provided either in the cartridges P or on the tray 51. In the first embodiment, the cartridges P have the respective photosensitive drums 61, the charging rollers 62, and the developing rollers 71.

The transfer unit 40 has a belt 41, primary transfer rollers 42, a cleaning portion 43, a drive roller 46 that drives the belt 41, and a tension roller 47 that serves as a driven roller. The image forming apparatus 1 has an optical sensor 44 that detects toner images transferred onto the belt 41. The belt 41 is arranged below the photosensitive drums 61 and is capable of contacting the photosensitive drums 61 so that a primary transfer portion is formed between the belt 41 and the photosensitive drums 61. Furthermore, the image forming apparatus 1 has a secondary transfer roller 45 that contacts the belt 41 so that a secondary transfer portion 48 is formed. The rotational axis directions of the primary transfer rollers 42, the drive roller 46, the tension roller 47, and the secondary transfer roller 45 are parallel to each other. A pair of registration rollers 4 is arranged upstream of the secondary transfer portion 48.

The fixing device 80 has a fixing portion 81 and a discharging and inversing portion 5. The fixing device 80 is capable of heating and pressing a sheet S in a use position. The fixing portion 81 has a heat roller 82 that serves as a heating portion including a heater, and a pressure roller 83 that serves as a pressure portion. A pair of discharge rollers 6 is arranged downstream of the fixing portion 81.

The front door 20 has the manual feeding tray 21 that is openable and closable relative to an apparatus body 1a. The manual feeding tray 21 has a rotation fulcrum 22 and is rotatably supported by the front door 20 about the rotation fulcrum 22. When the front door 20 is regarded as a part of the apparatus body 1a, it can be said that the manual feeding tray 21 is rotatably supported relative to the apparatus body 1a. The manual feeding tray 21 is rotatable between the closed position illustrated in FIG. 1 and the open position illustrated in FIG. 2. When the manual feeding tray 21 is in the open position as illustrated in FIG. 2, it is possible to load recording media on the manual feeding tray 21 and feed the recording media to the image forming apparatus 1 through a manual sheet feeding portion 33. That is, the manual feeding tray 21, which is an opening and closing member, functions as a tray on which recording media are loadable in the open position. The detailed configuration of the manual sheet feeding portion 33 will be described below.

### Operation of Image Forming Apparatus

The image forming operation of the image forming apparatus 1 will be described with reference to FIGS. 1 and 2. The control portion 3 of the image forming apparatus 1 starts the image forming operation on a sheet S on the basis of an image signal received from an external host apparatus 400. The external host apparatus 400 is, for example, a personal computer, an image reader, a facsimile machine, or the like.

As a charging voltage is applied to the charging rollers 62, the photosensitive drums 61 rotate. A laser beam corresponding to image information is irradiated from the scanner 2 onto the photosensitive drums 61, thereby exposing the surfaces of the photosensitive drums 61 charged by the charging rollers 62. As a result, electrostatic latent images corresponding to the image information are formed on the surfaces of the photosensitive drums 61.

The developing rollers 71 bear toner. A developing voltage is applied to the developing rollers 71, and the electrostatic latent images formed on the photosensitive drums 61 are developed by the toner supplied from the developing rollers 71, thereby forming toner images on the surfaces of the photosensitive drums 61.

When a full-color image is formed, a toner image of each color is formed on each of the photosensitive drums 61. The image forming apparatus 1 performs full-color printing in a state in which the developing rollers 71 and the photosensitive drums 61 corresponding to the cartridges PY, PM, PC, and PK are in contact with each other. The toner images formed on the respective photosensitive drums 61 are transferred onto the belt 41 by the primary transfer rollers 42 and are then conveyed toward the secondary transfer portion 48 formed by the belt 41 and the secondary transfer roller 45.

The supply of sheets S to the secondary transfer portion 48 is performed by the sheet feeding portion 30. In the sheet feeding portion 30, the sheets S loaded on the cassette 31 are separated by a feeding roller 32 at a specified timing, and one sheet S is conveyed toward the secondary transfer portion 48 and the fixing portion 81 through a first conveyance path 11. When printing is performed on the sheets S loaded on the manual feeding tray 21, the manual feeding tray 21 is opened as illustrated in FIG. 2, and the sheets S loaded on the manual feeding tray 21 are separated by a manual feeding roller 34 at a specified timing in the manual sheet feeding portion 33. Then, one sheet S is conveyed toward the secondary transfer portion 48 and the fixing portion 81 through a second conveyance path 12.

In the secondary transfer portion 48, the toner images are transferred from the belt 41 onto the sheet S. Note that the toner that has not been transferred onto the sheet S is removed from the belt 41 by a cleaning blade 43a that serves as a cleaning member provided inside the cleaning portion 43.

The sheet S, onto which the toner images have been transferred in the secondary transfer portion 48, is conveyed toward the fixing portion 81. In the fixing device 80, the sheet S is heated and pressurized by the fixing portion 81, and the toner images are fixed onto the sheet S. A flapper 84, which serves as a path switching member, is provided downstream of the fixing portion 81. The flapper 84 is switchable by an actuator (not illustrated) between the position indicated by the solid line and the position indicated by the broken line in the figure. When printing is performed on only one side of the sheet S, the flapper 84 is held at the position indicated by the solid line in the figure, and the sheet S is conveyed to a third conveyance path 13. The pair of discharge rollers 6 is provided downstream of the third conveyance path 13, and the sheet S is discharged to the outside of the apparatus by the pair of discharge rollers 6 and loaded on a sheet loading tray 7.

On the other hand, when double-sided printing is performed on both sides of the sheet S, the flapper 84 is held at the position indicated by the broken line, and the sheet S is conveyed to a fourth conveyance path 14 by a pair of inversion rollers 8 in the discharging and inversing portion 5. When the rear end of the sheet S is conveyed to the vicinity of a nip formed by the pair of inversion rollers 8, the flapper 84 is switched from the position indicated by the broken line to the position indicated by the solid line, and the rotational direction of the pair of inversion rollers 8 is reversed. As a result, the sheet S is conveyed to a fifth conveyance path 15, which serves as a double-sided conveyance path. After that, the sheet S is conveyed to the secondary transfer portion again through the pair of registration rollers 4. After the toner image is transferred to the second side of the sheet S in the secondary transfer portion, the sheet S is heated and pressurized in the fixing portion 81, thereby fixing the toner image onto the sheet S. The flapper 84 is held at the position indicated by the solid line in the figure, and the sheet S is discharged to the outside of the apparatus through the third conveyance path 13 and loaded on the sheet loading tray 7.

### Configuration of Manual Sheet Feeding Portion

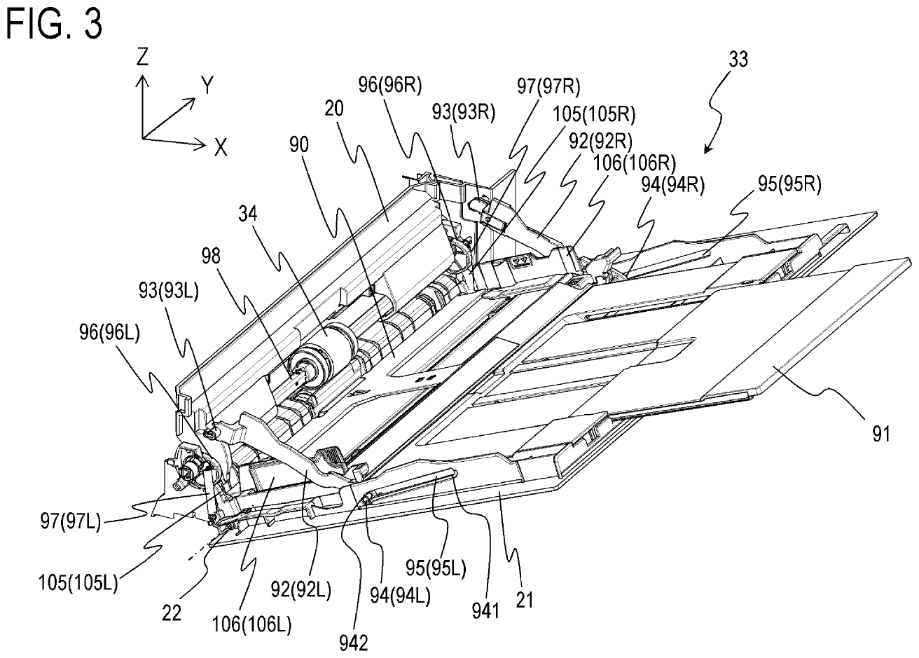

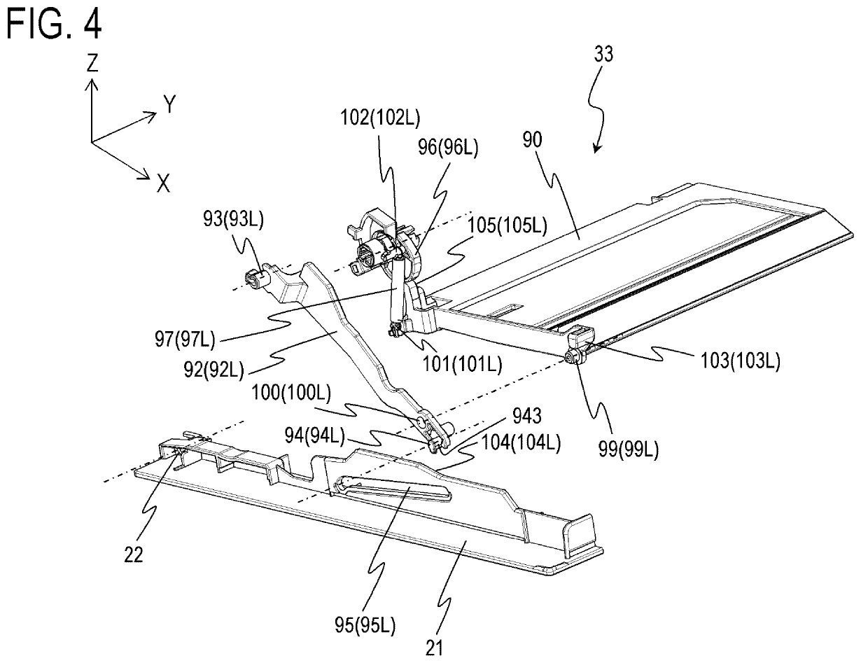

The configuration of the manual sheet feeding portion 33 will be described with reference FIGS. 3 and 4.

FIG. 3 is a perspective view illustrating the details of the periphery of the manual sheet feeding portion 33 in a state in which the manual feeding tray 21 is opened. The manual sheet feeding portion 33 has the manual feeding tray 21, a sheet loading plate 90, an extension tray 91, link members 92, cam members 96, and tension springs 97. FIG. 4 is an exploded perspective view illustrating a part of the manual feeding tray 21 and the manual sheet feeding portion 33. Note that the link members 92, the cam members 96, and the tension springs 97 are each symmetrically provided on the left and right sides in the horizontal direction (the Y direction) of the image forming apparatus 1. FIG. 4 illustrates only the configuration on the left side of the image forming apparatus 1. The reference numerals of the members (such as the link member 92L and the tension spring 97L) provided on the left side (the −Y direction) of the image forming apparatus 1 are assigned L, while the reference numerals of the members (such as the link member 92R and the tension spring 97R) provided on the right side (+Y direction) of the image forming apparatus 1 are assigned R. When it is not necessary to distinguish the components on the left and right sides from each other, L or R assigned to the components may be omitted.

As illustrated in FIG. 3, the link members 92 are each provided on the left and right sides (the Y direction) of the apparatus (the link members 92L and 92R). The link members 92 serve as connection members that connect the apparatus body 1a and the manual feeding tray 21. The link members 92 are configured to be movable relative to both the apparatus body 1a and the manual feeding tray 21.

First rotation fulcrum shafts 93L and 93R are provided on one end sides of the link members 92L and 92R, respectively. The first rotation fulcrum shafts 93L and 93R are engaged with rotation fulcrum holes formed in the front door 20, and the link members 92L and 92R are rotatably supported by the front door 20. The first rotation fulcrum shafts 93L and 93R serve as first engagement portions that are rotatably engaged with the apparatus body 1a. Note that in FIG. 3, a part of the front door 20 on the left side (the-Y direction) of the image forming apparatus 1 is not illustrated for convenience of explanation.

Slide shafts 94L and 94R are provided on the other end sides of the link members 92L and 92R, respectively. The slide shafts 94L and 94R are engaged with slide grooves 95L and 95R that are provided in the manual feeding tray 21. The slide shafts 94L and 94R are movably supported along the slide grooves 95L and 95R. The slide shafts 94L and 94R serve as second engagement portions that are movably engaged with the manual feeding tray 21.

As illustrated in FIG. 4, the slide shaft 94 has a protrusion portion 943 that is movable relative to the slide groove 95 while being inserted into the slide groove 95 provided in the manual feeding tray 21. As the manual feeding tray 21 rotates, the link member 92 also rotates in conjunction with the rotation of the manual feeding tray 21, and the slide shaft 94 moves inside the slide groove 95. The slide shaft 94 is movable relative to the manual feeding tray 21 between a first position 941 where it contacts one terminal end of the slide groove 95 and a second position 942 where it contacts the other terminal end, in conjunction with the rotation of the manual feeding tray 21. As a result, the open position of the manual feeding tray 21 is regulated. The manual feeding tray 21 is rotatable between a closed position (FIG. 1) where the slide shaft 94 is in the first position 941 and an open position (FIG. 2) where the slide shaft 94 is in the second position 942.

In a state in which the manual feeding tray 21 is opened as illustrated in FIG. 3, it is possible to load the sheet S on the sheet loading plate 90 and the extension tray 91 and feed the sheet S into the apparatus body 1a by a manual feeding roller 34. The manual feeding roller 34 is a feeding member that is capable of feeding the sheet S loaded on the manual feeding tray 21 into the apparatus body 1a. The extension tray 91 is configured to be slidable relative to the manual feeding tray 21 in a direction opposite to a sheet conveyance direction (approximately the X direction). The extension tray 91 is movable between the pullout position illustrated in FIG. 3 and an accommodation position (not illustrated) to which the extension tray 91 is slid from the pullout position in the sheet conveyance direction (substantially the −X direction). When a sheet S that is long in the sheet conveyance direction is used, the extension tray 91 is pulled out to the pullout position to support the bottom surface of the sheet S.

The cam members 96L and 96R are configured to rotate integrally with the manual feeding roller 34 through a feeding roller rotation shaft 98 (see FIG. 3).

As illustrated in FIG. 4, the sheet loading plate 90 has a second rotation fulcrum shaft 99. The second rotation fulcrum shaft 99 is engaged with a rotation fulcrum hole 100 provided in the link member 92, and the sheet loading plate 90 is rotatably supported by the link member 92. The second rotation fulcrum shaft 99 serves as a third engagement portion that is rotatably engaged with the link member 92. The rotation fulcrum hole 100 provided in the link member 92 serves as a fourth engagement portion that is engaged with the second rotation fulcrum shaft 99. As illustrated in FIG. 4, the rotation fulcrum hole 100 is provided between the first rotation fulcrum shaft 93 and the slide shaft 94. Furthermore, the distance between the rotation fulcrum hole 100 and the slide shaft 94 is shorter than that between the rotation fulcrum hole 100 and the first rotation fulcrum shaft 93.

A first spring hooked portion 101 and a cam follower portion 105 are provided on one end side of the sheet loading plate 90. Furthermore, a pressing portion 103 is provided, relative to the second rotation fulcrum shaft 99, at the position (the other end) opposite to the first spring hooked portion 101. That is, the first spring hooked portion 101 and the pressing portion 103 are located on mutually opposite sides relative to the second rotation fulcrum shaft 99. As illustrated in FIG. 4, the distance between the second rotation fulcrum shaft 99 and the pressing portion 103 is shorter than that between the second rotation fulcrum shaft 99 and the first spring hooked portion 101.

One end of the tension spring 97 is hooked onto the first spring hooked portion 101. The other end of the tension spring 97 is hooked onto a second spring hooked portion 102 integrally provided on the front door 20. The first spring hooked portion 101 serves as an urged portion to which one end of the tension spring 97 is attached, and the second spring hooked portion 102 serves as an attachment portion of the apparatus body 1a to which the other end of the tension spring 97 is attached. The tension spring 97 serves as an urging member that is capable of applying an urging force to the first spring hooked portion 101, which serves as the urged portion. The urged portion may also be referred to as a force receiving portion that receives a force from the tension spring 97.

The slide grooves 95, the second rotation fulcrum shafts 99, the first spring hooked portions 101, the second spring hooked portions 102, and the like, which are the members related to the link members 92 and the tension springs 97, are each symmetrically provided on the left and right sides in the horizontal direction (the Y direction).

When the manual feeding tray 21 is in the open position, the cam follower portion 105 is urged by the urging force of the tension spring 97 such that it contacts the outer peripheral surface of the cam member 96 (see FIGS. 3 and 4). When the sheet S is fed from the manual sheet feeding portion 33, the manual feeding roller 34 and the cam member 96 are rotated by a drive unit (not illustrated). Accordingly, the sheet loading plate 90 swings about the second rotation fulcrum shaft 99 (see FIG. 4), causing the sheet S to be separated and fed by the manual feeding roller 34 at a specified timing. As illustrated in FIG. 3, a pair of sheet width direction regulating plates 106L and 106R are provided on the sheet loading plate 90 to be movable in the width direction (the ±Y direction) of the sheet S. The user is allowed to adjust the position of each sheet width direction regulating plate 106 in accordance with the width size of the sheet S.

### Braking Configuration of Manual Feeding Tray

On the front side of the image forming apparatus 1, the manual feeding tray 21, which is openable and closable by the user, is provided. When feeding the sheet S using the manual sheet feeding portion 33, the user performs an operation to open the manual feeding tray 21 so that it is in the open position.

First, the configuration related to the opening and closing operation of the manual feeding tray 21 will be described with reference to FIGS. 3 and 4.

As illustrated in FIG. 3, when the manual feeding tray 21 is open, the tension spring 97 urges the first spring hooked portion 101 of the sheet loading plate 90 in a direction away from the manual feeding tray 21. When the tension spring 97 applies an urging force to the first spring hooked portion 101, the sheet loading plate 90 rotates about the second rotation fulcrum shaft 99, and the pressing portion 103 swings toward a pressed portion 104 provided on the manual feeding tray 21. That is, the tension spring 97 serves as an urging member that is capable of applying an urging force to the first spring hooked portion 101 in a direction in which the pressing portion 103 is pressed against the pressed portion 104. The pressed portion 104 is provided to correspond to a region where the slide groove 95 is formed, and is positioned to face the pressing portion 103 during the opening and closing of the manual feeding tray 21.

The sheet loading plate 90 is a pressing member having the second rotation fulcrum shaft 99, the pressing portion 103 that is capable of pressing the pressed portion 104, and the first spring hooked portion 101. The sheet loading plate 90 serves as a moving member that moves a recording medium loaded on the manual feeding tray 21 to the manual feeding roller 34. The sheet loading plate 90 rotates relative to the link member 92 in conjunction with the opening and closing of the manual feeding tray 21.

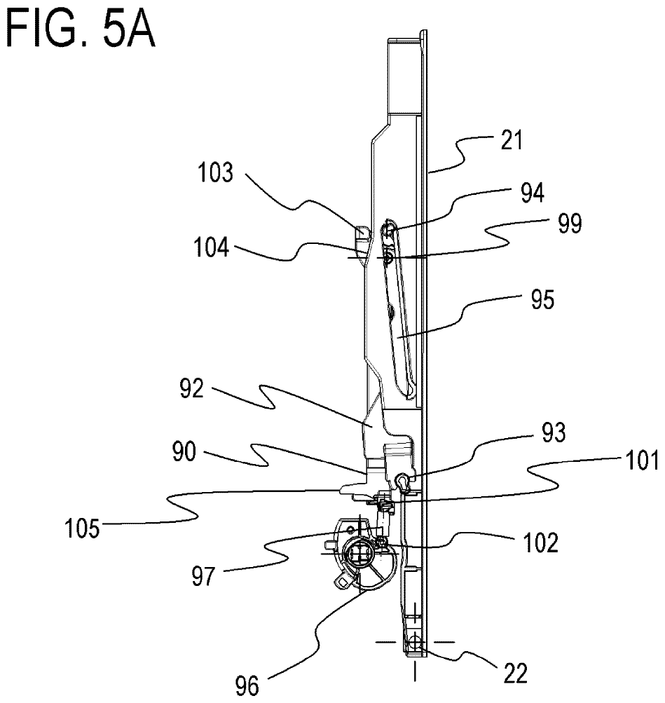

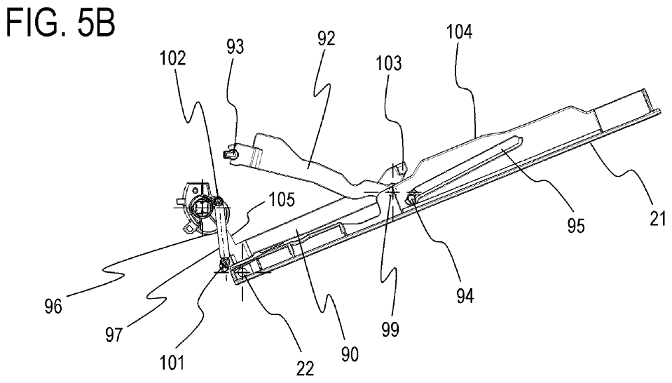

Next, the operation of the braking mechanism during the opening and closing operation of the manual feeding tray 21 will be described with reference to FIGS. 5A and 5B to FIGS. 8A and 8B.

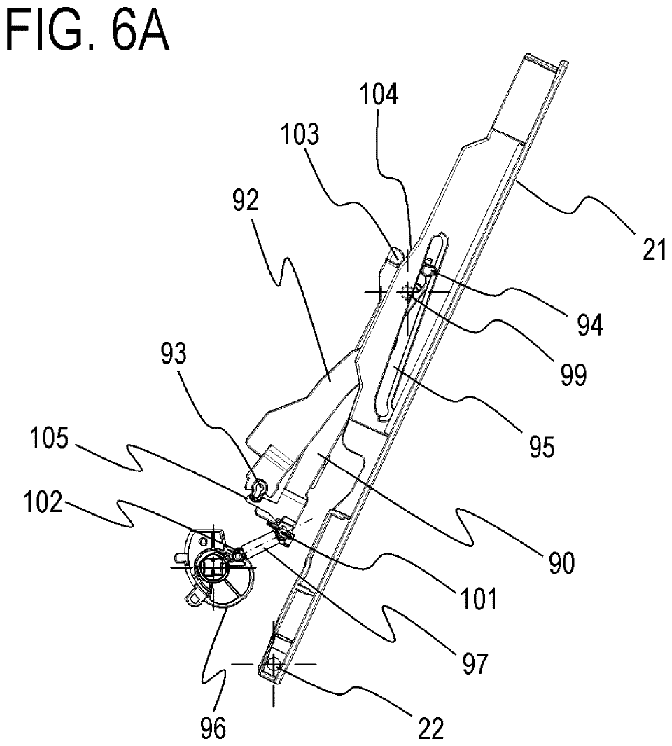

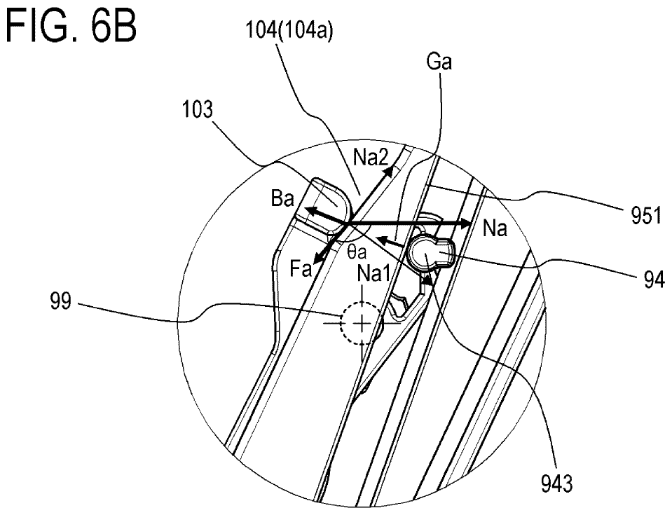

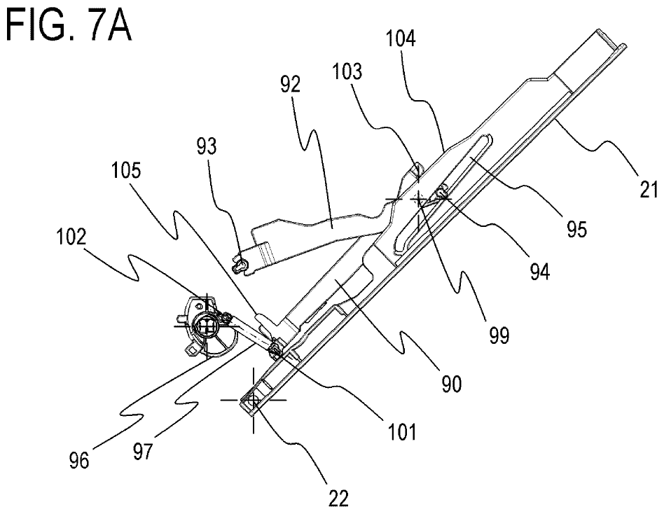

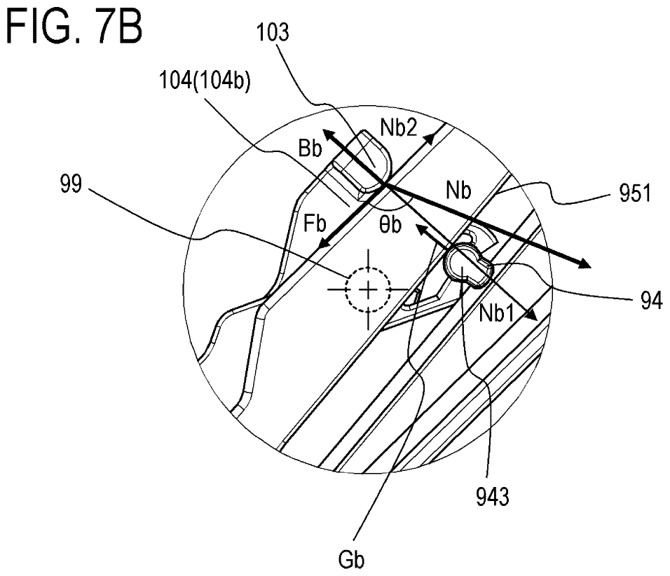

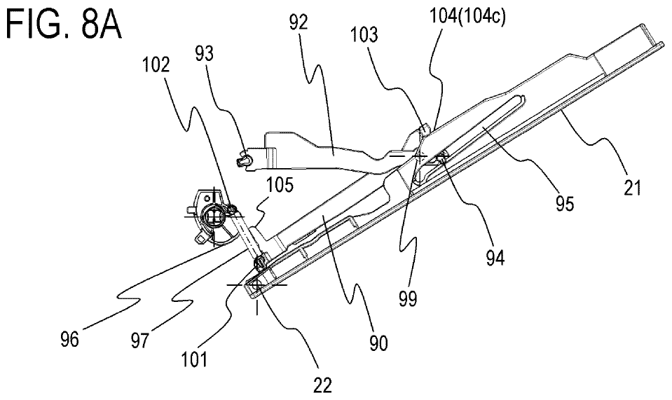

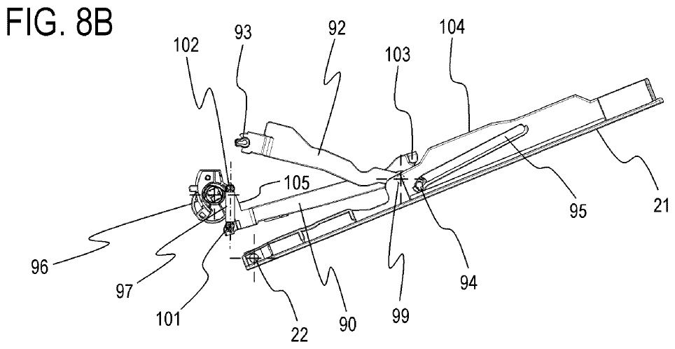

FIG. 5A is a view illustrating a state in which the manual feeding tray 21 is in the closed position. FIG. 5B is a view illustrating a state in which the manual feeding tray 21 is in the open position. FIGS. 6A and 6B illustrate a state in which the manual feeding tray 21 is slightly opened from the closed position. FIGS. 7A and 7B illustrate a state in which the manual feeding tray 21 is opened further than the state illustrated in FIGS. 6A and 6B. FIG. 8A illustrates a state in which the manual feeding tray 21 is opened further than the state illustrated in FIGS. 7A and 7B. FIG. 8B is a view illustrating a state in which the manual feeding tray 21 is in the open position and the sheet loading plate 90 is in the sheet feeding position. Note that FIGS. 6B and 7B are enlarged views of the pressing portion 103 and the pressed portion 104.

The pressed portion 104 is provided with a first contact portion 104a and a second contact portion 104b.

When the manual feeding tray 21 is opened from the closed position, the urging force of the tension spring 97 is applied to the sheet loading plate 90, causing the sheet loading plate 90 to rotate about the second rotation fulcrum shaft 99 as illustrated in FIGS. 6A and 6B. As the sheet loading plate 90 rotates, the pressing portion 103 contacts the first contact portion 104a of the pressed portion 104. By the urging force of the tension spring 97, the pressing portion 103 applies a pressing force Na to the first contact portion 104a of the pressed portion 104.

Furthermore, a pressing force Ga by which the protrusion portion 943 of the slide shaft 94 presses an inner wall 951 of the slide groove 95 and a pressing force Na by which the pressing portion 103 presses the pressed portion 104 have components in directions facing each other. Accordingly, the pressing force Ga and the pressing force Na are applied such that the slide shaft 94 and the pressing portion 103 sandwich and compress the pressed portion 104 of the manual feeding tray 21. In other words, in this embodiment, the pressing force Ga has a component in a direction toward the pressing portion 103 (a direction approaching the pressing portion 103), and the pressing force Na has a component in a direction toward the protrusion portion 943 (a direction approaching the protrusion portion 943).

Resulting from the application of the pressing force Na, a frictional force Fa is generated at the contact portion between the pressing portion 103 of the sheet loading plate 90 and the pressed portion 104 of the manual feeding tray 21. The frictional force Fa applied to the manual feeding tray 21 resists the movement of the manual feeding tray 21 in the opening direction about the rotation fulcrum 22. Accordingly, the component of the frictional force Fa in the rotational direction about the rotation fulcrum 22 is applied to the manual feeding tray 21 as a braking force Ba against the opening movement of the manual feeding tray 21.

In the state illustrated in FIG. 6B, the pressing portion 103 is in contact with the first contact portion 104a. The pressing force Na is decomposed into a vertical component Na1 and a horizontal component Na2 relative to the first contact portion 104a. When the frictional coefficient between the pressing portion 103 and the pressed portion 104 is denoted as μ, the difference between μNa1 and Na2 becomes the frictional force Fa acting on the first contact portion 104a. The component of the frictional force Fa in the rotational direction of the manual feeding tray 21 becomes the braking force Ba.

When the manual feeding tray 21 is further opened, the urging force of the tension spring 97 is applied to the sheet loading plate 90, causing the sheet loading plate 90 to rotate about the second rotation fulcrum shaft 99 as illustrated in FIGS. 7A and 7B. As the sheet loading plate 90 rotates, the pressing portion 103 contacts the second contact portion 104b of the pressed portion 104. By the urging force of the tension spring 97, the pressing portion 103 applies a pressing force Nb to the second contact portion 104b of the pressed portion 104.

Furthermore, a pressing force Gb by which the protrusion portion 943 of the slide shaft 94 presses the inner wall 951 of the slide groove 95 and a pressing force Nb by which the pressing portion 103 presses the pressed portion 104 have components in directions facing each other. Accordingly, the pressing force Gb and the pressing force Nb are applied such that the slide shaft 94 and the pressing portion 103 sandwich and compress the manual feeding tray 21. In other words, in this embodiment, the pressing force Gb has a component in a direction toward the pressing portion 103 (a direction approaching the pressing portion 103), and the pressing force Nb has a component in a direction toward the protrusion portion 943 (a direction approaching the protrusion portion 943).

Resulting from the application of the pressing force Nb, a frictional force Fb is generated at the contact portion between the pressing portion 103 of the sheet loading plate 90 and the pressed portion 104 of the manual feeding tray 21. The frictional force Fb applied to the manual feeding tray 21 resists the movement of the manual feeding tray 21 in the opening direction about the rotation fulcrum 22. Accordingly, the component of the frictional force Fb in the rotational direction about the rotation fulcrum 22 is applied to the manual feeding tray 21 as the braking force Bb against the opening movement of the manual feeding tray 21.

In the state illustrated in FIG. 7B, the pressing portion 103 is in contact with the second contact portion 104b. The pressing force Nb is decomposed into a vertical component Nb1 and a horizontal component Nb2 relative to the second contact portion 104b. The difference between μNb1 and Nb2 becomes the braking force Bb acting on the second contact portion 104b. The component of the frictional force Fb in the rotational direction of the manual feeding tray 21 becomes the braking force Bb.

The first contact portion 104a is a first portion of the pressed portion 104, and the second contact portion 104b is a second portion of the pressed portion 104. The angle formed between the movement direction (parallel to Fa) when the pressing portion 103 moves relative to the first contact portion 104a in conjunction with the rotation of the manual feeding tray 21 and the direction of the pressing force Na by which the pressing portion 103 presses the first contact portion 104a is defined as a first angle θa. The angle formed between the movement direction (parallel to Fb) when the pressing portion 103 moves relative to the second contact portion 104b in conjunction with the rotation of the manual feeding tray 21 and the direction of the pressing force Nb by which the pressing portion 103 presses the second contact portion 104b is defined as a second angle θb. At this time, the first angle θa and the second angle θb are different from each other.

Furthermore, as illustrated in FIGS. 5A and 5B to FIGS. 8A and 8B, the distance between the first spring hooked portion 101 and the second spring hooked portion 102 increases as the manual feeding tray 21 opens. Accordingly, the amount of deformation of the tension spring 97 from its natural state increases as the manual feeding tray 21 opens.

Thus, the braking force Bb becomes greater than the braking force Ba (Bb>Ba) due to the relationship between the magnitude of the pressing force Nb and the magnitude and direction of the frictional force Fb. Accordingly, it is possible to configure a braking mechanism that applies to the manual feeding tray 21 a braking force that increases as the manual feeding tray 21 opens.

The magnitudes of the pressing forces Na and Nb are determined by the magnitude of the urging force of the tension spring 97, the direction of the urging force applied by the tension spring 97 to the first spring hooked portion 101, and the distances from the second rotation fulcrum shaft 99 to the first spring hooked portion 101 and the pressing portion 103. The magnitudes of the pressing forces Na and Nb affect the magnitudes of the frictional forces Fa and Fb, respectively. By configuring the urging force of the tension spring 97 to increase as the manual feeding tray 21 opens, it is possible to make the pressing force Nb greater than the pressing force Na.

As described above, by appropriately setting the positional relationships between the second rotation fulcrum shaft 99, the first spring hooked portion 101, the second spring hooked portion 102, and the pressing portion 103, it is possible to configure the braking force to increase as the manual feeding tray 21 opens. In the first embodiment, the amount of deformation of the tension spring 97 from its natural state and the direction of the urging force applied to the first spring hooked portion 101 change according to the degree of opening of the manual feeding tray 21, thereby making the pressing force Nb greater than the pressing force Na (Nb>Na).

Furthermore, the magnitudes of the braking forces Ba and Bb generated during the rotation of the manual feeding tray 21 from the closed position to the open position are determined by the magnitudes and directions of the frictional forces Fa and Fb applied to the manual feeding tray 21, respectively. The magnitudes and directions of the frictional forces Fa and Fb are determined by the magnitudes of the pressing forces Na and Nb and the shape of the pressed portion 104. In the first embodiment, the shapes of the first contact portion 104a and the second contact portion 104b of the pressed portion 104 are set so that the braking force Bb becomes greater than the braking force Ba.

As illustrated in FIG. 5A, when the manual feeding tray 21 is in the closed position, the tension spring 97 does not act to rotate the sheet loading plate 90 about the second rotation fulcrum shaft 99. Accordingly, in a state in which the manual feeding tray 21 is in the closed position, the pressing portion 103 does not apply a pressing force to the manual feeding tray 21. That is, when the manual feeding tray 21 is in the closed position, the urging force of the tension spring 97 applied to the first spring hooked portion 101 spring hooked portion does not act to press the pressing portion 103 against the pressed portion 104, and the pressing portion 103 does not press the pressed portion 104. Therefore, no braking force is generated.

As illustrated in FIG. 5B, when the manual feeding tray 21 is in the open position, the pressing portion 103 is not in contact with the manual feeding tray 21. That is, when the manual feeding tray 21 is in the open position, the pressing portion 103 is not in contact with the pressed portion 104. Therefore, the pressing portion 103 does not press the pressed portion 104. Accordingly, when the manual feeding tray 21 is in the open position, the braking force B resulting from the action of the pressing portion 103 is not generated.

As described above, no braking force is applied to the manual feeding tray 21 in both the closed state and the open state. Accordingly, it is possible to prevent the user from having difficulty in closing the manual feeding tray 21 to a specified closed position or opening the same to a specified open position.

When the manual feeding tray 21 is between the closed position and the open position, the pressing portion 103 moves relative to the pressed portion 104 while pressing the pressed portion 104 under the urging force of the tension spring 97, in conjunction with the rotation of the manual feeding tray 21. When the manual feeding tray 21 moves from the closed position (FIG. 5A) to the open position (FIG. 5B), it passes through the third position (FIGS. 6A and 6B) and the fourth position (FIGS. 7A and 7B). Here, the fourth position is closer to the open position than the third position. The pressing force of the pressing portion 103, which presses the pressed portion 104, increases as the manual feeding tray 21 moves from the third position toward the fourth position. Further, the amount of deformation of the tension spring 97 from its natural state increases as the manual feeding tray 21 moves from the third position toward the fourth position. Accordingly, in the image forming apparatus 1 according to the first embodiment, it is possible to configure a braking mechanism that applies a greater braking force to the manual feeding tray 21 as the manual feeding tray 21 opens, while applying no braking force in both the open position and the closed position.

As described above, in order to prepare for a sheet feeding operation in the manual sheet feeding portion 33, the cam follower portion 105 contacts the outer peripheral surface of the cam member 96 under the urging force of the tension spring 97 when the manual feeding tray 21 is in the open position (see FIGS. 3 and 4). Here, when the cam follower portion 105 is in contact with the outer peripheral surface of the cam member 96, the urging force of the tension spring 97 is not applied as a braking force against the rotation of the manual feeding tray 21. Accordingly, it is possible to configure a braking mechanism that applies no braking force when the manual feeding tray 21 is in both the closed position and the open position.

During the opening of the manual feeding tray 21, the pressing portion 103 contacts the pressed portion 104 before the cam follower portion 105 contacts the cam member 96. As illustrated in FIG. 8A, the pressing portion 103 is in contact with the third contact portion 104c, thereby making it possible to regulate the posture of the sheet loading plate 90 and guide the cam follower portion 105 to the outer peripheral surface of the cam member 96. Accordingly, the cam member 96 does not hinder the user from opening the manual feeding tray 21 to the open position. Furthermore, even if the sheet loading plate 90 swings about the second rotation fulcrum shaft 99 when a sheet is fed from the manual sheet feeding portion 33 with the manual feeding tray 21 opened to the open position, the pressing portion 103 is configured so as not to contact the manual feeding tray 21 as illustrated in FIG. 8B. Accordingly, the braking mechanism does not affect the sheet feeding performance.

The tension springs 97L and 97R, the pressing portions 103L and 103R, and the pressed portions 104L and 104R are each symmetrically provided on the left and right sides (the Y direction) of the apparatus. The pressed portions 104 are provided on both end sides of the manual feeding tray 21 in the direction of its rotational axis. The pressing portions 103 are provided on both end sides of the sheet loading plate 90 in the direction of the rotational axis of the manual feeding tray 21. Accordingly, the braking force B is capable of being evenly applied to the left and right sides, thereby allowing the user to smoothly perform an operation without causing torsion or the like in the manual feeding tray 21 during an opening and closing operation.

As described above, by applying pressure with the pressing portion 103, a compressive force is imparted to the manual feeding tray 21 through the pressing portion 103 and the slide shaft 94, thereby allowing a braking force to be applied to the manual feeding tray 21.

Accordingly, it becomes possible to provide, in a manual feeding tray that is opened and closed by the user, a braking mechanism that applies an effective braking force in a small space, and to provide an image forming apparatus that improves the feel during user operation.

The operation of opening the manual feeding tray 21 is an operation of moving the manual feeding tray 21 in the gravity direction. In the image forming apparatus 1, a braking force is applied to the operation of opening the manual feeding tray 21. Therefore, it is possible to prevent the manual feeding tray 21 from opening with an excessive force against the user's intention, and to suppress the occurrence of a collision sound or bouncing when the manual feeding tray 21 reaches the open position.

Furthermore, as the manual feeding tray 21 opens, the position of the center of gravity changes, and the moment around the rotational axis increases. In the image forming apparatus 1, a braking force corresponding to the position of the manual feeding tray 21 is applied such that the braking force increases as the manual feeding tray 21 opens. Therefore, it is possible to apply an appropriate braking force during the opening and closing operation of the manual feeding tray 21.

Furthermore, when the manual feeding tray 21 is in both the open position and the closed position, no braking force is applied to the manual feeding tray 21. That is, the configuration is not such that a constant braking force is applied during the opening and closing operation of the manual feeding tray 21. Therefore, the user's operation of opening or closing the manual feeding tray 21 to a desired position is not obstructed by the braking force.

Furthermore, the frictional force generated by the sliding movement of the pressing portion 103 while pressing the pressed portion 104 is applied as a braking force against the opening and closing operation of the manual feeding tray 21. The pressed portion 104 is provided with the first contact portion 104a and the second contact portion 104b such that the angle formed between the movement direction of the pressing portion 103 and the direction of the pressing force changes. Furthermore, the amount of deformation of the tension spring 97 from its natural state is configured to change according to the degree of opening and closing of the manual feeding tray 21. Because the braking force changes in accordance with the degree of opening and closing of the manual feeding tray 21 under such a configuration, it is possible to configure a braking mechanism in a small space, and to improve the texture and operational feeling of the image forming apparatus.

### Second Embodiment

In the first embodiment, the configuration is described in which the pressing portion 103 presses the pressed portion 104, and the manual feeding tray 21 is sandwiched and compressed between the pressing portion 103 and the slide shaft 94 to apply a braking force. However, it is possible to obtain the same effect with other configurations.

In a second embodiment, a braking configuration that differs from that of the first embodiment and applies a braking force to the manual feeding tray will be described. Note that only the portions differing from those in the first embodiment will be described, and the descriptions of the same configurations as in the first embodiment will be omitted.

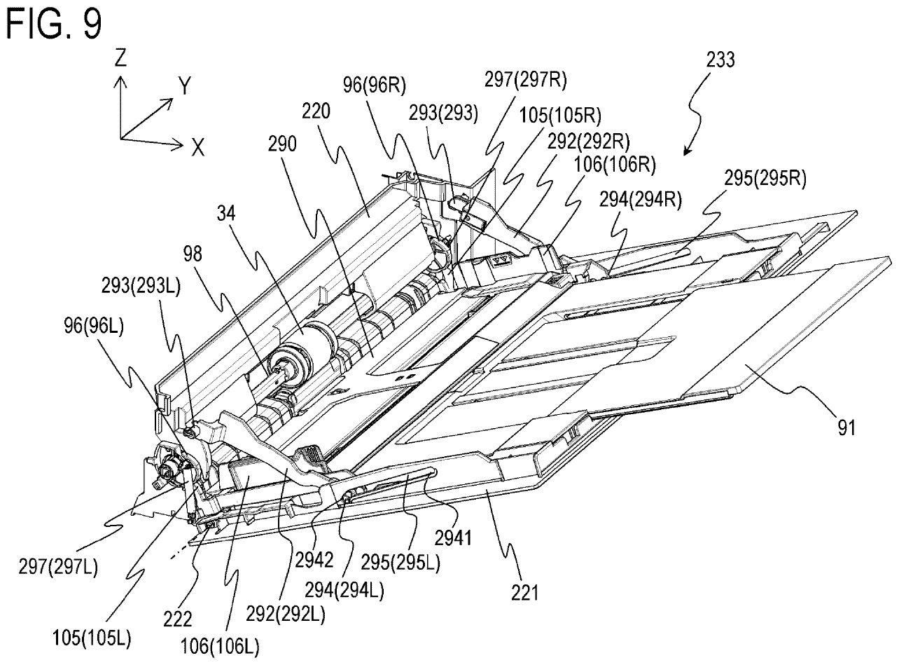

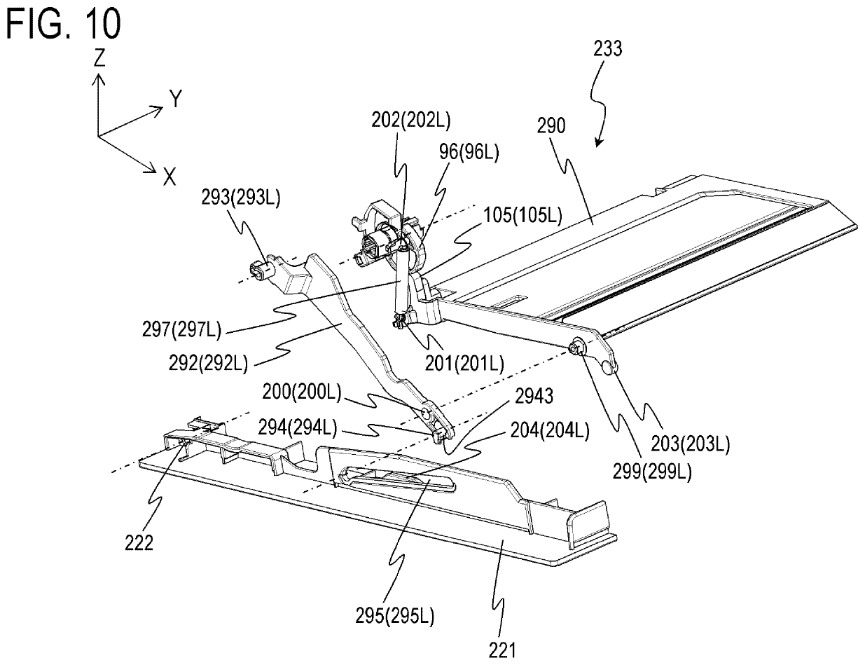

FIG. 9 is a perspective view illustrating the details of the periphery of a manual sheet feeding portion 233 in a state in which a manual feeding tray 221 is opened. FIG. 10 is an exploded perspective view illustrating a part of the manual feeding tray 221 and the manual sheet feeding portion 233.

First, the configuration of the manual sheet feeding portion 233 will be described with reference to FIGS. 9 and 10.

As illustrated in FIG. 9, the manual sheet feeding portion 233 has the manual feeding tray 221, a sheet loading plate 290, link members 292, and tension springs 297. The link members 292 and the tension springs 297 are each symmetrically provided on the left and right sides in the horizontal direction (the Y direction) of the image forming apparatus 1. Furthermore, slide grooves 295, second rotation fulcrum shafts 299, first spring hooked portions 201, second spring hooked portions 202, and the like, which are the members related to the link members 292 and the tension springs 297, are each symmetrically provided on the left and right sides in the horizontal direction (the Y direction). The reference numerals of the members (such as the link member 292L and the tension spring 297L) provided on the left side (the −Y direction) of the image forming apparatus 1 are assigned L, while the reference numerals of the members (such as the link member 292R and the tension spring 297R) provided on the right side (the +Y direction) of the image forming apparatus 1 are assigned R.

The manual feeding tray 221 has a rotation fulcrum 222, and a front door 220 rotatably supports the manual feeding tray 221 about the rotation fulcrum 222. The manual feeding tray 221 serves as an opening and closing member rotatably supported relative to the apparatus body 1a.

The link members 292 have first rotation fulcrum shafts 293 on one end side and slide shafts 294 on the other end side. The first rotation fulcrum shafts 293 are engaged with rotation fulcrum holes formed in the front door 220, and the link members 292 are rotatably supported by the front door 220. The first rotation fulcrum shafts 293 serve as first engagement portions that are rotatably engaged with the apparatus body 1a. The slide shafts 294 are engaged with slide grooves 295 provided in the manual feeding tray 221 and are movably supported along the slide grooves 295. The slide shafts 294 serve as second engagement portions that are movably engaged with the manual feeding tray 221. The link members 292 serve as connection members that connect the apparatus body 1a and the manual feeding tray 221.

As the manual feeding tray 221 rotates, the link members 292 also rotate, and the slide shafts 294 move inside the slide grooves 295. Each of the slide shafts 294 has a protrusion portion 2943 that is movable relative to the slide groove 295 while being inserted into the slide groove 295 provided in the manual feeding tray 221. The slide shaft 294 is movable relative to the manual feeding tray 221 between a first position 2941 where it contacts one terminal end of the slide groove 295 and a second position 2942 where it contacts the other terminal end, in conjunction with the rotation of the manual feeding tray 221. As a result, the open position of the manual feeding tray 221 is regulated. The manual feeding tray 221 is rotatable between a closed position where the slide shaft 294 is in the first position 2941 and an open position where the slide shaft 294 is in the second position 2942.

As illustrated in FIG. 10, the sheet loading plate 290 has a second rotation fulcrum shaft 299. The second rotation fulcrum shaft 299 is engaged with a rotation fulcrum hole 200 provided in the link member 292, and the sheet loading plate 290 is rotatably supported by the link member 292. The second rotation fulcrum shaft 299 serves as a third engagement portion that is rotatably engaged with the link member 292. The rotation fulcrum hole 200 provided in the link member 292 serves as a fourth engagement portion that is engaged with the second rotation fulcrum shaft 299. The rotation fulcrum hole 200 is provided between the first rotation fulcrum shaft 293 and the slide shaft 294. Furthermore, the distance between the rotation fulcrum hole 200 and the slide shaft 294 is shorter than that between the rotation fulcrum hole 200 and the first rotation fulcrum shaft 293.

The first spring hooked portion 201 and the cam follower portion 105 are provided on one end side of the sheet loading plate 290. Furthermore, a pressing portion 203 is provided, relative to the second rotation fulcrum shaft 299, at the position (the other end) opposite to the first spring hooked portion 201. That is, the first spring hooked portion 201 and the pressing portion 203 are located on mutually opposite sides relative to the second rotation fulcrum shaft 299. As illustrated in FIG. 10, the distance between the second rotation fulcrum shaft 299 and the pressing portion 203 is shorter than that between the second rotation fulcrum shaft 299 and the first spring hooked portion 201.

One end of the tension spring 297 is hooked onto the first spring hooked portion 201. The other end of the tension spring 297 is hooked onto a second spring hooked portion 202 integrally provided on the front door 220. The first spring hooked portion 201 serves as an urged portion to which one end of the tension spring 297 is attached, and the second spring hooked portion 202 serves as an attachment portion of the apparatus body 1a to which the other end of the tension spring 297 is attached. The tension spring 297 serves as an urging member that is capable of applying an urging force to the first spring hooked portion 201, which serves as an urged portion.

As illustrated in FIG. 9, when the manual feeding tray 221 is open, the tension spring 297 urges the first spring hooked portion 201 of the sheet loading plate 290 in a direction away from the manual feeding tray 221. As illustrated in FIG. 10, when the tension spring 297 applies an urging force to the first spring hooked portion 201, the sheet loading plate 290 rotates about the second rotation fulcrum shaft 299, and the pressing portion 203 swings toward a pressed portion 204 provided on the manual feeding tray 221. That is, the tension spring 297 serves as an urging member that is capable of applying an urging force to the first spring hooked portion 201 in a direction in which the pressing portion 203 is pressed against the pressed portion 204. The pressed portion 204 is provided to correspond to a region where the slide groove 295 is formed, and is positioned to face the pressing portion 203 during the opening and closing of the manual feeding tray 221.

The sheet loading plate 290 serves as a pressing member having the second rotation fulcrum shaft 299, the pressing portion 203 that is capable of pressing the pressed portion 204, and the first spring hooked portion 201. The sheet loading plate 290 also serves as a moving member that moves a recording medium loaded on the manual feeding tray 221 to the manual feeding roller 34. The sheet loading plate 290 rotates relative to the link member 292 in conjunction with the opening and closing of the manual feeding tray 221.

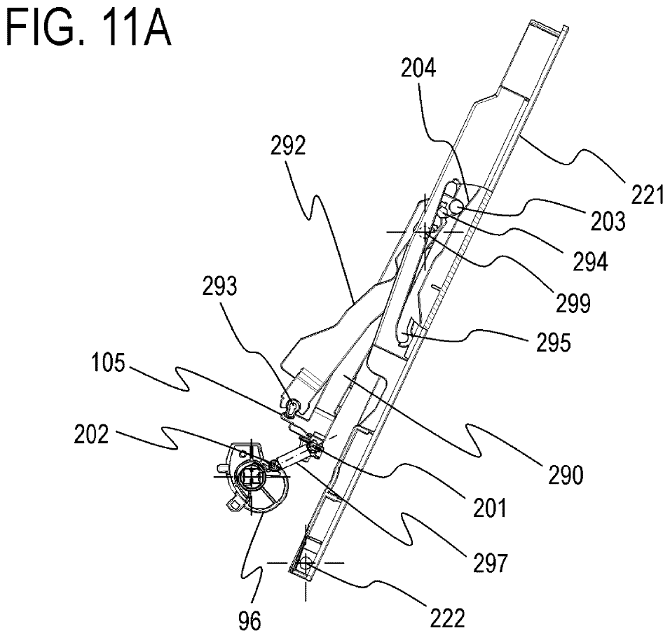

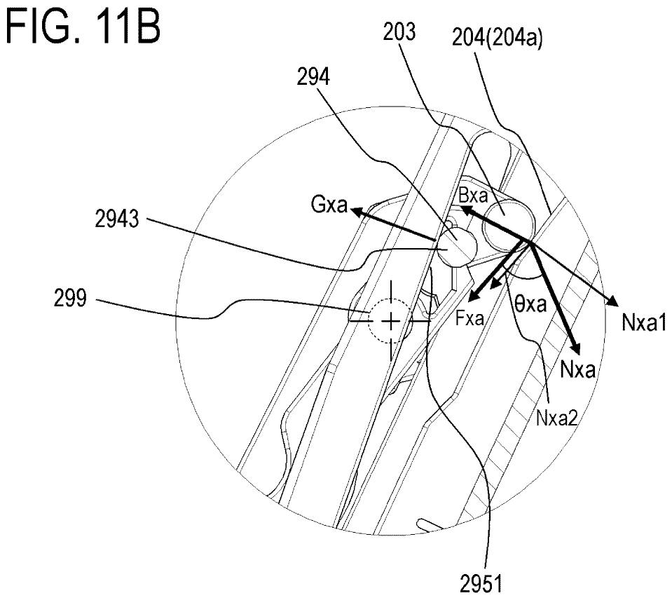

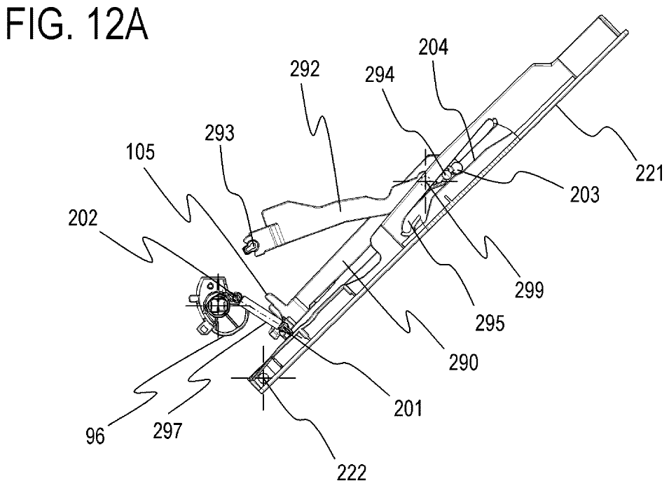

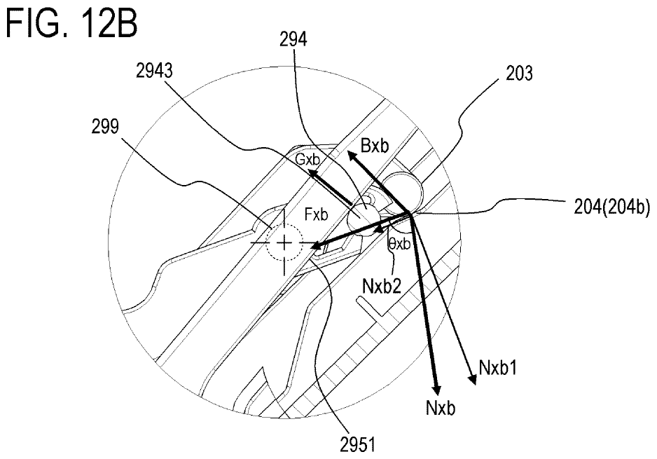

Next, the operation of the braking mechanism during the opening and closing operation of the manual feeding tray 221 will be described with reference to FIGS. 11A and 11B and FIGS. 12A and 12B.

FIGS. 11A and 11B illustrate a state in which the manual feeding tray 221 is slightly opened from the closed position. FIGS. 12A and 12B illustrate a state in which the manual feeding tray 221 is opened further than the state illustrated in FIGS. 11A and 11B. FIGS. 11B and 12B are enlarged views of the pressing portion 203 and the pressed portion 204.

The pressed portion 204 is provided with a first contact portion 204a and a second contact portion 204b.

When the manual feeding tray 221 is opened from the closed position, the urging force of the tension spring 297 is applied to the sheet loading plate 290, causing the sheet loading plate 290 to rotate about the second rotation fulcrum shaft 299 as illustrated in FIGS. 11A and 11B. As the sheet loading plate 290 rotates, the pressing portion 203 contacts the first contact portion 204a of the pressed portion 204. By the urging force of the tension spring 297, the pressing portion 203 applies a pressing force Nxa to the first contact portion 204a of the pressed portion 204.

Furthermore, a pressing force Gxa by which the protrusion portion 2943 of the slide shaft 294 presses an inner wall 2951 of the slide groove 295 and a pressing force Nxa by which the pressing portion 203 presses the pressed portion 204 have components in directions away from each other. Accordingly, the pressing force Gxa and the pressing force Nxa are applied such that the slide shaft 294 and the pressing portion 203 separate the pressed portion 204 of the manual feeding tray 221 from the inner wall 2951. In other words, in this embodiment, the pressing force Gxa has a component in a direction opposite to the pressing portion 203 (a direction away from the pressing portion 203), and the pressing force Nxa has a component in a direction opposite to the protrusion portion 2943 (a direction away from the protrusion portion 2943).

Resulting from the application of the pressing force Nxa, a frictional force Fxa is generated at the contact portion between the pressing portion 203 of the sheet loading plate 290 and the pressed portion 204 of the manual feeding tray 221. The frictional force Fxa applied to the manual feeding tray 221 resists the movement of the manual feeding tray 221 in the opening direction about the rotation fulcrum 222. Accordingly, the component of the frictional force Fxa in the rotational direction about the rotation fulcrum 222 is applied to the manual feeding tray 221 as a braking force Bxa against the opening movement of the manual feeding tray 221.

In the state illustrated in FIG. 11B, the pressing portion 203 is in contact with the first contact portion 204a. The pressing force Nxa is decomposed into a vertical component Nxa1 and a horizontal component Nxa2 relative to the first contact portion 204a. When the frictional coefficient between the pressing portion 203 and the pressed portion 204 is denoted as μ, the sum of μNxa1 and Nxa2 becomes the frictional force Fxa acting on the first contact portion 204a. The component of the frictional force Fxa in the rotational direction of the manual feeding tray 221 becomes a braking force Bxa.

When the manual feeding tray 221 is further opened, the urging force of the tension spring 297 is applied to the sheet loading plate 290, causing the sheet loading plate 290 to rotate about the second rotation fulcrum shaft 299 as illustrated in FIGS. 12A and 12B. As the sheet loading plate 290 rotates, the pressing portion 203 contacts the second contact portion 204b of the pressed portion 204. By the urging force of the tension spring 297, the pressing portion 203 applies a pressing force Nxb to the second contact portion 204b of the pressed portion 204.

Furthermore, a pressing force Gxb by which the protrusion portion 2943 of the slide shaft 294 presses the inner wall 2951 of the slide groove 295 and a pressing force Nxb by which the pressing portion 203 presses the pressed portion 204 have components in directions away from each other. Accordingly, the pressing force Gxb and the pressing force Nxb are applied such that the slide shaft 294 and the pressing portion 203 separate the pressed portion 204 of the manual feeding tray 221 from the inner wall 2951. In other words, in this embodiment, the pressing force Gxb has a component in a direction opposite to the pressing portion 203 (a direction away from the pressing portion 203), and the pressing force Nxb has a component in a direction opposite to the protrusion portion 2943 (a direction away from the protrusion portion 2943).

Resulting from the application of the pressing force Nxb, a frictional force Fxb is generated at the contact portion between the pressing portion 203 of the sheet loading plate 290 and the pressed portion 204 of the manual feeding tray 221. The frictional force Fxb applied to the manual feeding tray 221 resists the movement of the manual feeding tray 221 in the opening direction about the rotation fulcrum 222. Accordingly, the component of the frictional force Fxb in the rotational direction about the rotation fulcrum 222 is applied to the manual feeding tray 221 as a braking force Bxb against the opening movement of the manual feeding tray 221.

In the state illustrated in FIG. 12B, the pressing portion 203 is in contact with the second contact portion 204b. The pressing force Nxb is decomposed into a vertical component Nxb1 and a horizontal component Nxb2 relative to the second contact portion 204b. The sum of μNxb1 and Nxb2 becomes a frictional force Fxb acting on the second contact portion 204b. The component of the frictional force Fxb in the rotational direction of the manual feeding tray 221 becomes the braking force Bxb.

The first contact portion 204a is a first portion of the pressed portion 204, and the second contact portion 204b is a second portion of the pressed portion 204. The angle formed between the movement direction (parallel to Fxa) when the pressing portion 203 moves relative to the first contact portion 204a in conjunction with the rotation of the manual feeding tray 221 and the direction of the pressing force Nxa by which the pressing portion 203 presses the first contact portion 204a is defined as a first angle θxa. The angle formed between the movement direction (parallel to Fxb) when the pressing portion 203 moves relative to the second contact portion 204b in conjunction with the rotation of the manual feeding tray 221 and the direction of the pressing force Nxb by which the pressing portion 203 presses the second contact portion 204b is defined as a second angle θxb. At this time, the first angle θxa and the second angle θxb are different from each other.

Furthermore, as illustrated in FIGS. 11A and 11B and FIGS. 12A and 12B, the distance between the first spring hooked portion 201 and the second spring hooked portion 202 increases as the manual feeding tray 221 opens. Accordingly, the amount of deformation of the tension spring 297 from its natural state increases as the manual feeding tray 221 opens.

Thus, the braking force Bxb becomes greater than the braking force Bxa (Bxb>Bxa) due to the relationship between the magnitude of the pressing force Nxb and the magnitude and direction of the frictional force Fxb. Accordingly, it is possible to configure a braking mechanism that applies to the manual feeding tray 221 a braking force that increases as the manual feeding tray 221 opens.

The magnitudes of the pressing forces Nxa and Nxb are determined by the magnitude of the urging force of the tension spring 297, the direction of the urging force applied by the tension spring 297 to the first spring hooked portion 201, and the distances from the second rotation fulcrum shaft 299 to the first spring hooked portion 201 and the pressing portion 203. The magnitudes of the pressing forces Nxa and Nxb affect the magnitudes of the frictional forces Fxa and Fxb, respectively. By configuring the urging force of the tension spring 297 to increase as the manual feeding tray 221 opens, it is possible to make the pressing force Nxb greater than the pressing force Nxa.

As described above, by appropriately setting the positional relationships between the second rotation fulcrum shaft 299, the first spring hooked portion 201, the second spring hooked portion 202, and the pressing portion 203, it is possible to configure the braking force to increase as the manual feeding tray 221 opens. In the second embodiment, the amount of deformation of the tension spring 297 from its natural state and the direction of the urging force applied to the first spring hooked portion 201 change according to the degree of opening of the manual feeding tray 221, thereby making the pressing force Nxb greater than the pressing force Nxa (Nxb>Nxa).

Furthermore, the magnitudes of the braking forces Bxa and Bxb generated during the rotation of the manual feeding tray 221 from the closed position to the open position are determined by the magnitudes and directions of the frictional forces Fxa and Fxb applied to the manual feeding tray 221, respectively. The magnitudes and directions of the frictional forces Fxa and Fxb are determined by the magnitudes of the pressing forces Nxa and Nxb and the shape of the pressed portion 204. In the second embodiment, the shapes of the first contact portion 204a and the second contact portion 204b of the pressed portion 204 are set so that the braking force Bxb becomes greater than the braking force Bxa.

As described above, by applying pressure with the pressing portion 203, a force in an opposite direction is imparted to the inner wall of the slide groove 295 of the manual feeding tray 221 through the pressing portion 203 and the slide shaft 294, thereby allowing a braking force to be applied to the manual feeding tray 221. Furthermore, the pressing portion 203 and the pressed portion 204 are arranged relative to the second rotation fulcrum shaft 299 such that the components Nxa2 and Nxb2, which are the components of the pressing forces Nxa and Nxb in the movement direction of the pressing portion 203, act in the same direction as the frictional forces Fxa and Fxb. Therefore, it is possible to more effectively generate the braking forces Bxa and Bxb.

Accordingly, it becomes possible to provide, in a tray that is opened and closed by the user, a braking mechanism that applies an effective braking force in a small space, and to provide an image forming apparatus that improves the feel during user operation.

According to the present disclosure, it is possible to apply an appropriate braking force to the opening and closing operation when the user opens and closes the opening and closing member.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-167320, filed on Sep. 26, 2024, which is hereby incorporated by reference herein in its entirety.

What is claimed is:

1. An image forming apparatus comprising:
an apparatus body;
an opening and closing member being rotatable relative to the apparatus body and having a pressed portion;
a connection member that connects the apparatus body and the opening and closing member, the connection member having a first engagement portion that is engaged with the apparatus body and a second engagement portion that is engaged with the opening and closing member, the connection member being movable relative to the apparatus body and the opening and closing member,
a pressing member having a third engagement portion that is rotatably engaged with the connection member, a pressing portion configured to press the pressed portion, and an urged portion; and
an urging member configured to apply an urging force to the urged portion such that the pressing portion is pressed against the pressed portion,
wherein the second engagement portion is movable relative to the opening and closing member between a first position and a second position in conjunction with rotation of the opening and closing member,
wherein the opening and closing member is rotatable between a closed position where the second engagement portion is in the first position and an open position where the second engagement portion is in the second position, and
wherein, in a case where the opening and closing member is between the closed position and the open position, the pressing portion moves relative to the pressed portion while pressing the pressed portion under the urging force of the urging member, in conjunction with the rotation of the opening and closing member.

2. The image forming apparatus according to claim 1,
wherein the urged portion and the pressing portion are located on mutually opposite sides relative to the third engagement portion.

3. The image forming apparatus according to claim 1,
wherein, in a case where the opening and closing member moves from the closed position to the open position, the opening and closing member passes through a third position and a fourth position, the fourth position is closer to the open position than the third position is to the open position, and
wherein a pressing force by which the pressing portion presses the pressed portion increases as the opening and closing member moves from the third position toward the fourth position.

4. The image forming apparatus according to claim 3,
wherein the urging member is a spring having one end attached to the urged portion and the other end attached to an attachment portion of the apparatus body, and
wherein an amount of deformation of the spring increases as the opening and closing member moves from the third position toward the fourth position.

5. The image forming apparatus according to claim 1,
wherein the connection member has a fourth engagement portion that is engaged with the third engagement portion, and
wherein the fourth engagement portion is between the first engagement portion and the second engagement portion.

6. The image forming apparatus according to claim 5,
wherein a distance between the fourth engagement portion and the second engagement portion is shorter than a distance between the fourth engagement portion and the first engagement portion.

7. The image forming apparatus according to claim 1,
wherein a distance between the third engagement portion and the pressing portion is shorter than a distance between the third engagement portion and the urged portion.

8. The image forming apparatus according to claim 1,
wherein, in a case where the opening and closing member is in the closed position, the pressing portion does not press the pressed portion.

9. The image forming apparatus according to claim 1,
wherein, in a case where the opening and closing member is in the closed position, the urging force of the urging member applied to the urged portion does not act to press the pressing portion against the pressed portion.

10. The image forming apparatus according to claim 1,
wherein, in a case where the opening and closing member is in the open position, the pressing portion does not press the pressed portion.

11. The image forming apparatus according to claim 10,
wherein, in a case where the opening and closing member is in the open position, the pressing portion is not in contact with the pressed portion.

12. The image forming apparatus according to claim 1,
wherein the pressed portion has a first portion and a second portion,
wherein, in a case where an angle formed between (i) a movement direction in a case where the pressing portion moves relative to the first portion in conjunction with the rotation of the opening and closing member and (ii) a direction of a pressing force by which the pressing portion presses the first portion is defined as a first angle, and
an angle formed between (iii) a movement direction in a case where the pressing portion moves relative to the second portion in conjunction with the rotation of the opening and closing member and (iv) a direction of a pressing force by which the pressing portion presses the second portion is defined as a second angle,
the first angle and the second angle are different from each other.

13. The image forming apparatus according to claim 1,
wherein the opening and closing member functions as a tray on which a recording medium is loadable in the open position,
the image forming apparatus further includes a feeding member configured to feed the recording medium loaded on the tray into the apparatus body,
wherein the pressing member is a moving member that moves the recording medium loaded on the tray toward the feeding member, and
wherein the moving member rotates relative to the connection member in conjunction with opening and closing of the tray.

14. The image forming apparatus according to claim 1,
wherein the second engagement portion has a protrusion portion that is movable relative to a groove while being inserted into the groove provided in the opening and closing member.

15. The image forming apparatus according to claim 14,
wherein a pressing force by which the protrusion portion presses an inner wall of the groove and a pressing force by which the pressing portion presses the pressed portion have components in directions facing each other.

16. The image forming apparatus according to claim 14,
wherein a pressing force by which the protrusion portion presses an inner wall of the groove and a pressing force by which the pressing portion presses the pressed portion have components in directions away from each other.
